(19) United States
(12) Patent Application Publication
(10) Pub. No.: US 2018/0121050 A1
(43) Pub. Date: May 3, 2018

(54) DEVICE, SYSTEM, AND PROCESS FOR WIRELESS SERVICE OPTIMIZATION BASED ON A LOCATION-BASED COVERAGE PROFILE

(71) Applicant: TracFone Wireless, Inc., Miami, FL (US)

(72) Inventor: Satish Ramprasad, Miami, FL (US)

(21) Appl. No.: 15/798,613

(22) Filed: Oct. 31, 2017

Related U.S. Application Data
(60) Provisional application No. 62/414,867, filed on Oct. 31, 2016.

(51) Int. Cl. G06F 3/0488; G06F 3/041; H04W 4/14; H04M 1/02; H04L 12/24; H04W 4/02

(52) U.S. Cl. CPC G06F 3/0488; G06F 3/0416; H04W 4/02; H04M 1/0202; H04L 41/0823; H04W 4/14

(57) ABSTRACT

A method and device are disclosed for determining optimized wireless service for a wireless device. The method including displaying on a display of the device a graphical user interface having a prompt to input information, wherein the information comprises at least one of the following: where a wireless user uses their wireless device, where the wireless user calls to with their wireless device, amount of voice usage, amount of data usage, and amount of text message usage, receiving the information into the graphical user interface displayed on the display of the device, transmitting the information from the device to a server, receiving in the device optimized wireless service information from the server, and displaying the optimized wireless service information in the graphical user interface on the display of the device.

### CROSS REFERENCE TO PRIOR APPLICATIONS

This application claims the benefit from U.S. Provisional Application No. 62/414,867 filed on Oct. 31, 2016, which is hereby incorporated by reference in its entirety for all purposes as if fully set forth herein.

### BACKGROUND OF THE DISCLOSURE

### 1. Field of the Disclosure

The disclosure generally relates to a device, system, and process for wireless service optimization. Moreover, the disclosure generally relates to a device, system, and process for wireless service optimization based on a location-based coverage profile.

### 2. Related Art

Currently when wireless service users are looking to optimize their wireless coverage, there typically is no clear way for the wireless service user to be able to ascertain what wireless service provider will provide the best wireless coverage for the wireless user's wireless service as it relates to the wireless users anticipated location geographically (where the user is located) and anticipated wireless usage (where the user calls). In other words, where the wireless user anticipates using their wireless device geographically (e.g., city, a metropolitan area, state, country, and the like); and where the wireless user anticipates calling geographically (e.g., city, a metropolitan area, state, country, and the like).

Accordingly, a need exists in the art for innovative processes, systems, devices, and applications to provide a convenient manner for a user to determine an optimal wireless plan.

### SUMMARY OF THE DISCLOSURE

The foregoing needs are met, to a great extent, by the disclosure, with a process, system, device and application to determine an optimal wireless plan.

One aspect of the disclosure is directed to a method for determining optimized wireless service for a wireless device implemented in a device including displaying on a display of the device a graphical user interface having a prompt to input information, wherein the information includes at least one of the following: where a wireless user uses their wireless device, where the wireless user calls to with their wireless device, an amount of voice usage, an amount of data usage, and an amount of text message usage, receiving the information into the graphical user interface displayed on the display of the device, transmitting the information from the device to a server, receiving in the device optimized wireless service information from the server, and displaying the optimized wireless service information in the graphical user interface on the display of the device.

Another aspect of the disclosure is directed to a device configured to provide wireless service optimization including a display of the device configured to display a graphical user interface having a prompt to input information, wherein the information includes at least one of the following: where a wireless user uses their wireless device, where the wireless user calls to with their wireless device, an amount of voice usage, an amount of data usage, and an amount of text message usage, the graphical user interface displayed on the display of the device being configured to receive the information, the device further configured to transmit the information to a server, the device further configured to receive optimized wireless service information from the server, and the device and display configured to display the optimized wireless service information in the graphical user interface on the display of the device.

There has thus been outlined, rather broadly, certain aspects of the disclosure in order that the detailed description thereof herein may be better understood, and in order that the present contribution to the art may be better appreciated. There are, of course, additional aspects of the disclosure that will be described below and which will form the subject matter of the claims appended hereto.

In this respect, before explaining at least one aspect of the disclosure in detail, it is to be understood that the disclosure is not limited in its application to the details of construction and to the arrangements of the components set forth in the following description or illustrated in the drawings. The disclosure is capable of aspects or aspects in addition to those described and of being practiced and carried out in various ways. Also, it is to be understood that the phraseology and terminology employed herein, as well as the abstract, are for the purpose of description and should not be regarded as limiting.

Reference in this application to “one aspect,” “an aspect,” “one or more aspects,” “an aspect” or the like means that a particular feature, structure, or characteristic described in connection with the aspect is included in at least one aspect of the disclosure. The appearances of, for example, the phrases “an aspect” in various places in the specification are not necessarily all referring to the same aspect, nor are separate or alternative aspects mutually exclusive of other aspects. Moreover, various features are described which may be exhibited by some aspects and not by the other. Similarly, various requirements are described which may be requirements for some aspects but not by other aspects.

As such, those skilled in the art will appreciate that the conception upon which this disclosure is based may readily be utilized as a basis for the designing of other structures, methods and systems for carrying out the several purposes of the disclosure. It is important, therefore, that the claims be regarded as including such equivalent constructions insofar as they do not depart from the spirit and scope of the disclosure.

### BRIEF DESCRIPTION OF THE DRAWINGS

In order to facilitate a fuller understanding of the disclosure, reference is now made to the accompanying drawings, in which like elements are referenced with like numerals. These drawings should not be construed as limiting the disclosure and intended only to be illustrative.

FIG. 1 illustrates a device in accordance with an aspect of the disclosure.

FIG. 2 illustrates a device process in accordance with an aspect of the disclosure.

FIGS. 3, 4, 5, and 6 illustrate graphical user interface screens of a device in accordance with an aspect of the disclosure.

FIG. 7 illustrates a device process in accordance with an aspect of the disclosure.

FIG. 8 illustrates an interface screen of a device in accordance with an aspect of the disclosure.

FIG. 9 illustrates a wireless service optimization system in accordance with an aspect of the disclosure.

FIG. 10 illustrates a wireless service optimization system process in accordance with an aspect of the disclosure.

FIG. 11 illustrates an interface screen of a device in accordance with an aspect of the disclosure.

### DETAILED DESCRIPTION

In today's marketplace, it would be beneficial to equip a wireless device user with the tools necessary to efficiently and effectively determine the best wireless carrier and optimal wireless billing plan. Preferably, the wireless service optimization may be accomplished on a wireless device or other Internet enabled device without requiring live customer service agents. In one aspect, it would be beneficial to make the wireless optimization process relatively simple and straightforward.

Generally speaking, a wireless user may provide a location based coverage profile that may be represented by mapping a location of a broad area where the wireless user needs coverage. For example, a user could be asked to provide the information on a map, what is their likely coverage area where they need service (not just a billing zip code), but more specific information such as a city, cities, portion of a city, metropolitan area, and the like. Additionally or alternatively, the wireless user could enter one or more metro areas for the coverage profile. Moreover, the wireless user can provide where they call to, in general terms, within a state, out of state, out of country, a particular country, particular countries, etc. Additionally, the wireless user can provide a weightage on where they need the phone the most; and the wireless user can provide a weightage on where they call the most. This information may form a coverage profile.

Thereafter, the coverage profile may be used in identifying the best wireless carrier and/or wireless service plan to activate their lines on, and direct them to a billing plan to serve their needs. In this regard, the best wireless carrier and/or wireless service plan may be the lowest cost wireless carrier and/or wireless service plan. The coverage profile may be limited to wireless phone calls. However, it may be additionally extended to optimize data usage, text message usage, and the like.

The disclosure may help wireless users to easily and quickly identify the best wireless plan and/or wireless carrier for their specific needs. It may be particularly beneficial for Mobile Virtual Network Operators (MVNOs) that include a number of wireless carriers and a number of wireless service plans including numerous brands and offerings. However, aspects of the disclosure may be equally applicable to Mobile Network Operators (MNO). The disclosure may help wireless users identify the best plan through a measurable metric such as data usage, coverage, talk, text, etc.

It is to be understood that system components and method steps described in this application may be employed in various forms of hardware, software, firmware, special purpose processors, and the like, or a combination thereof. In one aspect, an application may be directed to a process and system utilizing a software application comprising executable code that is operably stored on one or more tangible non-transitory program storage devices including but not limited to a magnetic floppy disk, RAM, ROM, CD ROM and/or Flash memory.

In aspects including a “wireless network,” the network may encompass any type of wireless network from which a Mobile Virtual Network Operator (MVNO) contracts with a Mobile Network Operator (MNO) wireless carrier to provide wireless services through the use of an electronic device, such as a Long Term Evolution (LTE) network, a fifth generation (5G) network, a Global System for Mobile Communication (GSM) network, Code-Division Multiple Access (CDMA) network, a network utilizing a communication channel as defined herein or the like, that may utilize the teachings of the disclosure to allow a wireless device to connect to a wireless network. In other aspects, the network may include a post-paid wireless carrier or Mobile Network Operators (MNO) that maintains and controls their own wireless networks. Namely, a MNO heavily relies on backend systems to address any provisional, billing, security and data issues that might threaten the health of their networks. In this regard, the disclosure may be implemented to determine optimal wireless service for a wireless device provisioned by a MNO or a MVNO.

In one aspect of the disclosure, there is described a method for improving user experience to determine an optimal wireless plan utilizing a wireless device or other Internet enabled device. That is, determining an optimal wireless plan may be initiated via a wireless service optimization application 106 that determines an optimal wireless service provider. In other aspects, the wireless service optimization application may be implemented through a browser application.

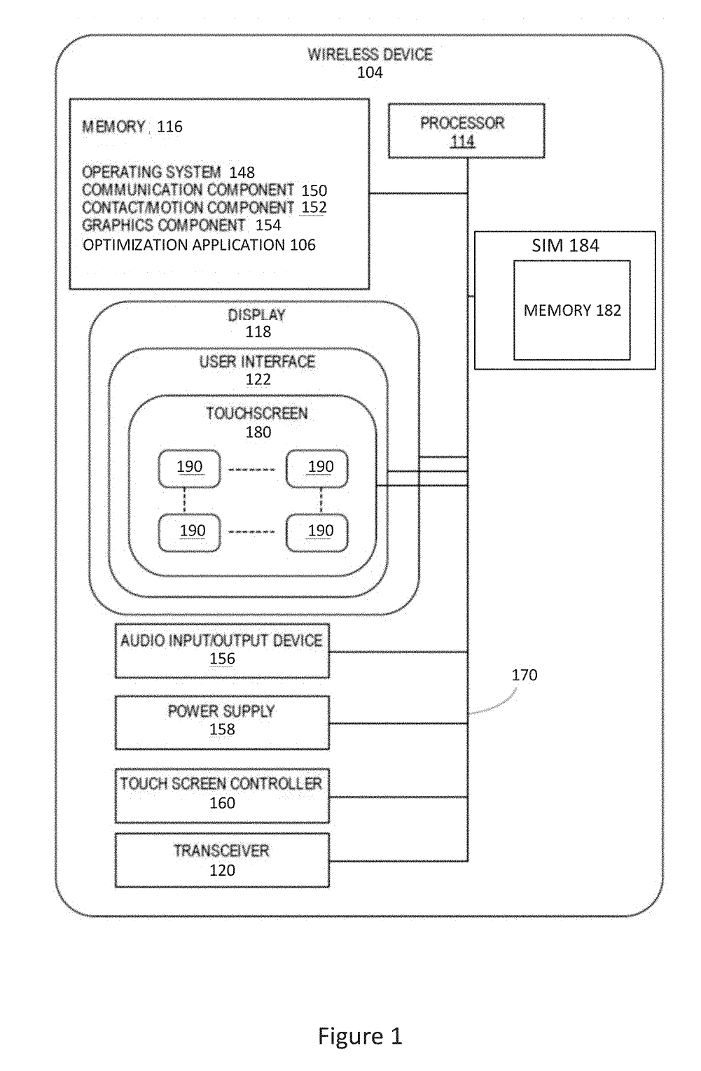

FIG. 1 illustrates a device in accordance with an aspect of the disclosure. In this regard, the disclosure may be implemented in conjunction with a wireless device 104 executing the wireless service optimization application 106. In another aspect, the disclosure may be implemented in an Internet enabled device 194 implementing a browser that provides the functionality consistent with the wireless service optimization application 106 implemented by a server. In another aspect, the wireless device 104 may implement a browser that provides the functionality consistent with the wireless service optimization application 106 implemented by a server. The wireless device 104 includes a memory 116. The wireless device 104 may further include an operating system 148, a communication component 150, a contact/motion component 152, a graphics component 154, and the like. The operating system 148 together with the various components provides software functionality for each of the components of the wireless device 104. The memory 116 may include a high-speed, random-access memory. Also, the memory 116 may be a non-volatile memory, such as magnetic fixed disk storage, flash memory or the like. These various components may be connected through various communication lines including a data bus 170. The memory 116 may also store device related information including but not limited to a device serial number, such as, for example, an International Mobile Equipment Identify (IMEI), an Electronic Serial Number (ESN), Mobile Equipment Identifier (MEID), and/or the like.

In another aspect of the disclosure, the memory 116 of a wireless device 104 includes a database for storing user information. The user information may include further information as required by the service provider and may include information such as full name, address, date of birth, telephone number, service provider, email address, contact number, credit card information, and the like. In one aspect, the database may include security questions. In another aspect, the database may include user specified preferences.

The wireless device 104 may also include a SIM card 184 having a memory 182. The memory 182 stores the SIM card serial number, and may be implemented as, for example, an integrated Circuit Card ID (ICCID). Aspects of the disclosure may be equally applicable to wireless devices 104 that are implemented without a SIM card 184 having a memory 182. The SIM 184 may be based on ISO/IEC 7812. In some aspects, the SIM 184 may also be a soft SIM, electronic SIM, or embedded SIM.

The wireless device 104 also includes a processor 114 which may be a central processing unit configured to execute instructions, such as, for example, instructions related to software programs. Any processor can be used for the wireless device 104 as understood by those of ordinary skill in the art. The processor 114 may be coupled to the user interface 122, the SIM card 184 and the memory 116. The display 118 may be a liquid crystal display (LCD). Preferably the LCD includes a backlight to illuminate the various color liquid crystals to provide a more colorful display. The user interface 122 may be any type of physical input as readily employed in the field. For example, the user interface may have physical buttons. Alternatively, the user interface may be implemented on a touchscreen 180. Additionally, the wireless device 104 includes a power supply 158. The wireless service optimization application 106 may be executed by the processor 114.

The wireless device 104 may include an audio input/output device 156. The audio input/output device 156 may include speakers, speaker outputs, microphones, microphone inputs, and the like, for receiving and sending sound inputs. In an exemplary aspect, the audio input/output device 156 may include an analog to digital converter and a digital to audio converter for audio input and output functions respectively.

In a further aspect, the wireless device 104 may include a transceiver 120. The wireless device 104 may provide radio and signal processing as needed to access a network for services in conjunction with the transceiver 120. The processor 114 may be configured to process call functions, data transfer, and the like and provide other services to the user.

In an exemplary aspect, the touchscreen 180 of the disclosure may be implemented in the display 118 and may detect a presence and location of a touch of a user within the display area. For example, touching the display 118 of the wireless device 104 with a finger or hand. The touchscreen 180 may also sense other passive objects, such as a stylus. The wireless device 104 may further include a touch screen controller 160.

In operation, the display 118 may show various objects 190 associated with applications for execution by the processor 114. For example, a user may touch the display 118, particularly the touchscreen 180, to interact with the objects 190. That is, touching an object 190 may execute an application in the processor 114 associated with the object 190 that is stored in memory 116. Additionally or alternatively, touching an object 190 may open a menu of options to be selected by the user. The display 118 may include a plurality of objects 190 for the user to interact with. Moreover the display 118 may include a plurality of screens. The display 118 showing one screen at a time. The user may interact with the display 118 to move a screen into view on the display 118. Various objects 190 may be located in each of the screens.

The touchscreen 180 may have different implementations. The touchscreen 180 may be implemented as a resistive touchscreen, a surface acoustic wave touch screen, a capacitive touch screen, a surface capacitance touchscreen, projected capacitive touch screen, self-capacitance sensors, infrared sensors, dispersive signal technology, acoustic pulse recognition, or the like.

The display 118 is generally configured to display a graphical user interface (GUI) 122 that provides an easy to use visual interface between a user of the wireless device 104 and the operating system or application(s) running on the wireless device 104. Generally, the GUI presents programs, files and operational options with graphical images. During operation, the user may select and activate various graphical images which appear on the display 118 in order to initiate functions and tasks associated therewith.

The internet enabled device 194 may include many of the same components as the wireless device 104 described above. Nevertheless, for brevity, the disclosure will focus on the implementation in the wireless device 104. However, it should be appreciated that the disclosed implementation is equally applicable to an Internet enabled device 194 that may be implemented as a personal computer (PC), laptop, personal digital assistant (PDA), tablet computer, workstation, or the like. In one aspect, implementing the Internet enabled device 194, the wireless service optimization application 106 may be implemented in a server that renders a graphical user interface in a browser of the Internet enabled device 194.

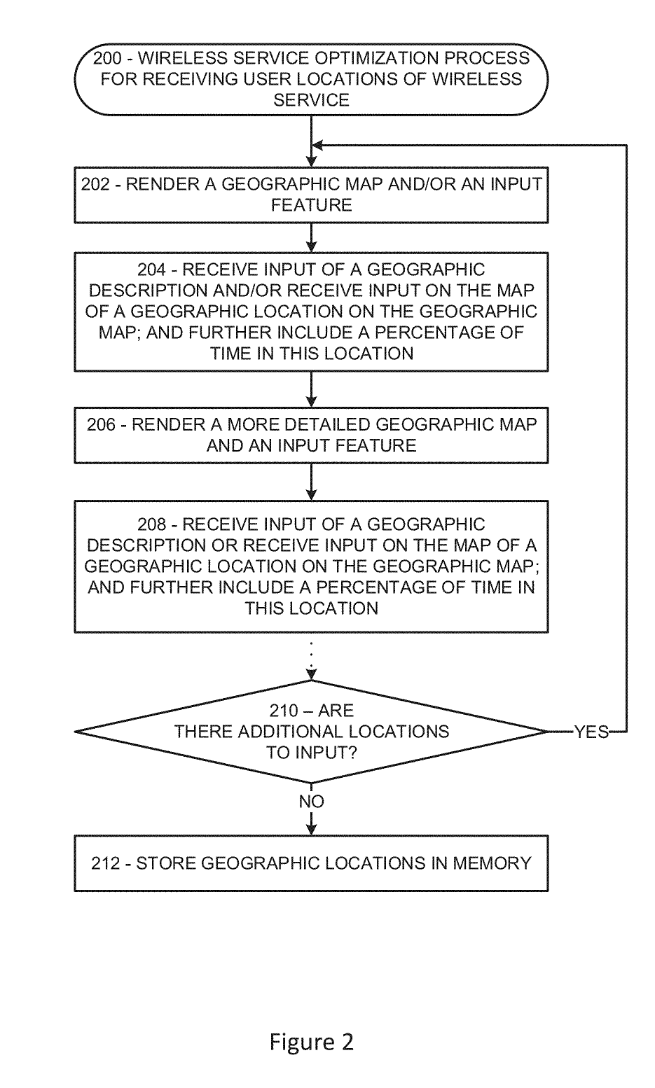

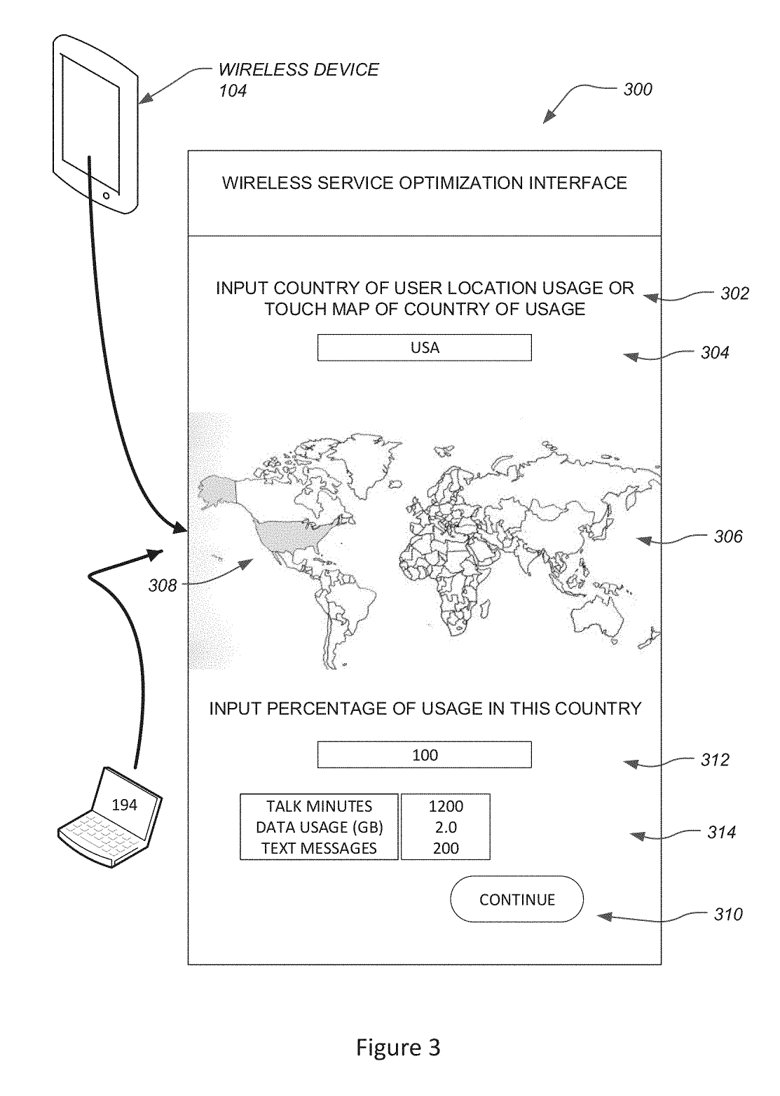

FIG. 2 illustrates a device process in accordance with an aspect of the disclosure; and FIGS. 3, 4, 5, 6 illustrate graphical user interface screens of a device in accordance with an aspect of the disclosure. In particular, FIG. 2 illustrates a wireless service optimization process for receiving user locations of wireless service 200. In one aspect, the FIG. 2 process is implemented by the wireless device 104. In another aspect, the FIG. 2 process is implemented by a server rendering in a browser of the Internet enabled device 194 the graphical user interfaces described herein.

As shown in box 202, the wireless device 104 may render a geographic map 306 and/or an input feature 304 in a graphical user interface 300 as illustrated in FIG. 3. In this regard, the geographic map 306 shown in FIG. 3 is of the world. Of course, it should be appreciated that a different map of less than the world may be rendered as well. The graphical user interface 300 may further provide a query 302 to a user to input a country.

Next, as shown in box 204, the graphical user interface 300 may receive input of a geographic description and/or receive an input on a map of a geographic location on the geographic map 306. The graphical user interface 300 of the wireless device 104 may be touch sensitive allowing the user to select various countries in the world that they are likely to be present in and use the wireless device 104. In one aspect, the graphical user interface 300 may allow the user to select multiple countries by touching the geographic map 306 multiple times in different locations. In one aspect, the geographic map 306 illustrated in the graphical user interface 300 may highlight the selected countries by changing color, providing a listing, or the like. In this regard, the user has selected the United States 308. Accordingly, the graphical user interface 300 illustrating the geographic map 306 shows the United States 308 highlighted.

In another aspect, the user may simply type in “USA” in an input feature 304. Thereafter, the United States 308 may be highlighted on the geographic map 306 (as shown), provided as a listing, or the like. Additionally, the input feature 304 may also include a drop-down menu listing of various countries in an alphabetic format, a frequency of use format, or the like, allowing the user to select a particular country. Other manners of inputting the user's location of country of usage are contemplated as well.

In a further aspect, the graphical user interface 300 may also allow the user to further include a percentage of time in this location. In this regard, an input box 312 may allow a user to input a percent of time in the United States 308. In this regard, the user anticipates using their wireless device in United States 100% of the time. The input box 312 may be implemented in other ways such as a sliding scale, radio buttons, and the like. Moreover, although only one country is shown selected in the graphical user interface 300, multiple countries may be selected in a single rendering of the graphical user interface 300. Alternatively, multiple renderings of the graphical user interface 300 may be generated allowing the user to select one country at a time. In a similar manner, additional input boxes 314 may allow the user to input anticipated usage amounts of voice minutes, data usage, and text message usage. The input box 314 may be implemented in other ways such as a sliding scale, radio buttons, and the like. In one aspect, once this information is input into the graphical user interface 300, the process may automatically advance. In another aspect, the user may be required to press a continue 310 button or similar input feature to advance the process 200.

In box 206, the wireless device 104 may render a more detailed geographic map showing greater detail of a selected country and/or an input feature. In this regard, as the United States was selected, a map of the United States 406 is rendered, the graphical user interface 400 may display the detailed map allowing the user to select and input more detailed locations of where they intend to utilize the wireless device 104. The graphical user interface 400 may further provide a query 402 to a user to input a particular location within a selected country. In this regard, the user has selected the state of Florida 408. Alternatively, the user may input the state in a box 404 as illustrated in the graphical user interface 400. Of course, if other countries are selected, then the graphical user interface 400 may provide detail locations, regions, and the like within that selected country.

In a further aspect, the graphical user interface 400 may also allow the user to further input anticipated percentage of time in this location. In this regard, an input box 412 may allow a user to input a percent of time in Florida 408. The input box 412 may be implemented in other ways such as a sliding scale, radio buttons, and the like. Moreover, although only one state is shown selected in the graphical user interface 400, multiple states may be selected in a single rendering of the graphical user interface 400. Alternatively, multiple renderings of the graphical user interface 400 may be generated allowing the user to select one state at a time. In one aspect, once this information is input into the graphical user interface 400, the process 200 may automatically advance. In another aspect, the user may be required to press a continue 410 button or similar input feature to advance the process 200.

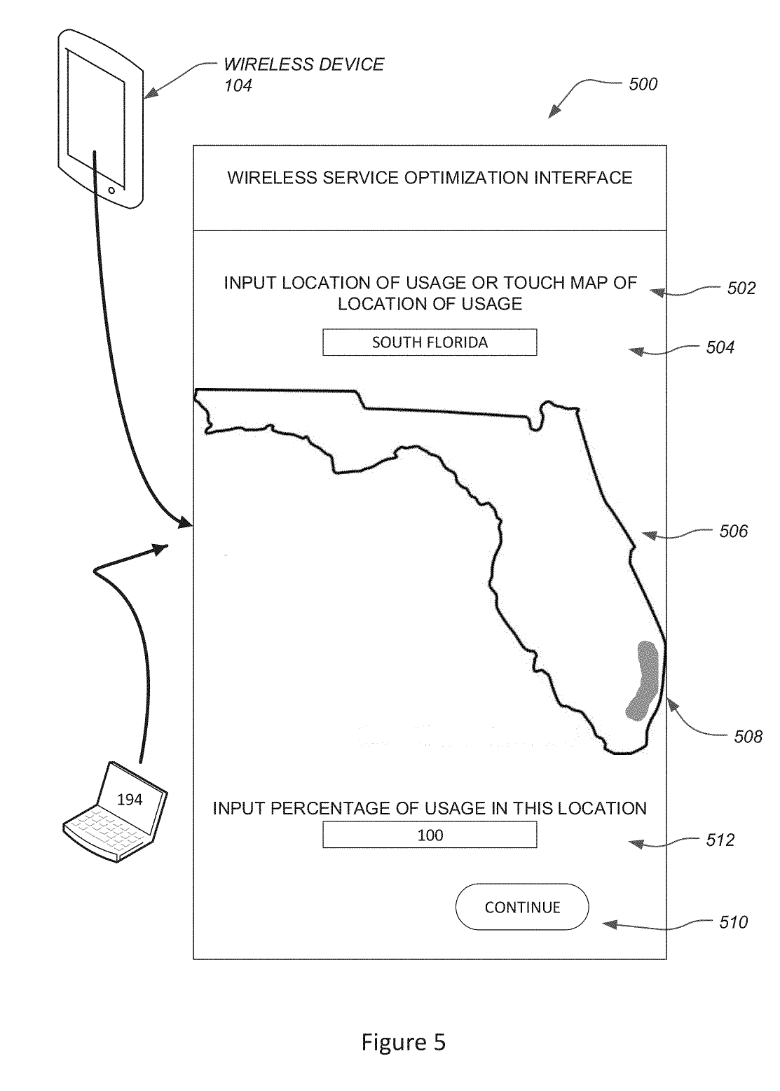

Moreover, as shown by the dashed arrow extending from box 208, the process 200 may continue with additional more detailed renderings of a geographic map and/or input box. For example, the graphical user interface 500 of FIG. 5 may further provide a query 502 to a user to input a more detailed location within the selected country. The graphical user interface 500 shown in FIG. 5 now provides a rendering of the state of Florida 506 with greater detail that allows a user to select the South Florida area 508 utilizing the touch sensitive nature of the wireless device 104. Additionally or alternatively, the graphical user interface 500 may include an input box 504 which allows input of the South Florida area 508. Finally, the graphical user interface 500 may include an input box 512 for receiving a percentage of usage in this location. In one aspect, once this information is input into the graphical user interface 500, the process 200 may automatically advance. In another aspect, the user may be required to press a continue 510 button or similar input feature to advance the process 200.

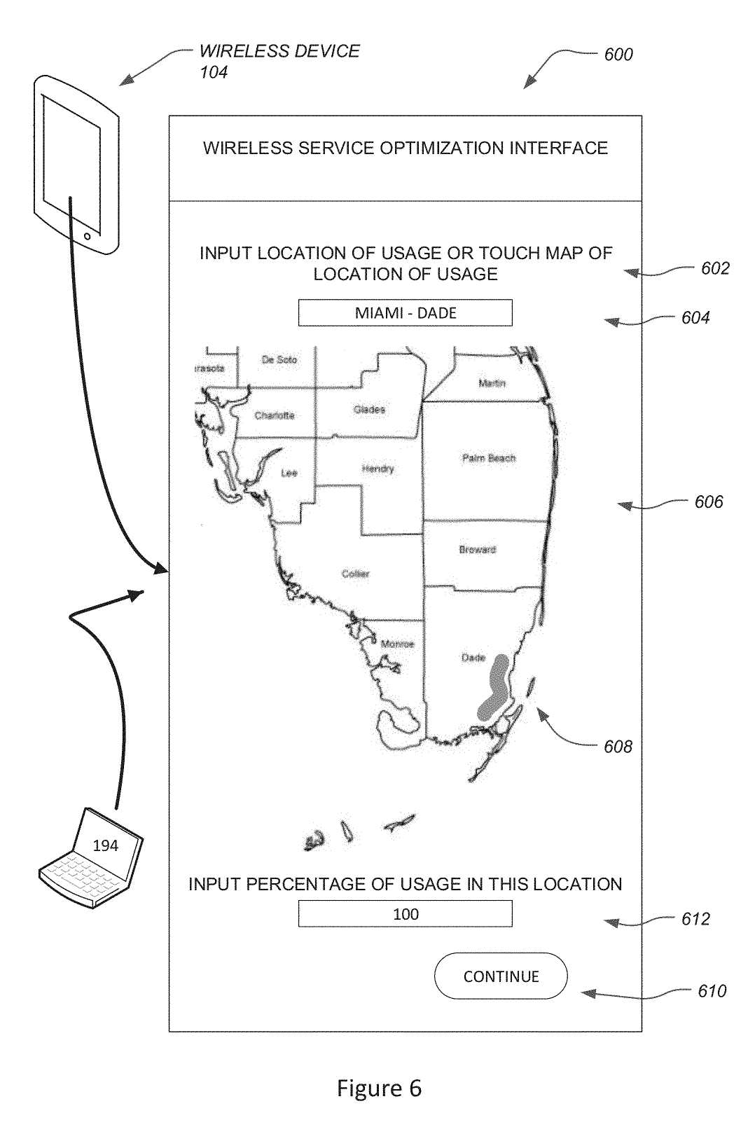

As a further example, the graphical user interface 600 in FIG. 6 now provides a rendering of South Florida 606 with greater detail that allows a user to select the Miami area 608 utilizing the touch sensitive nature of the wireless device 104. The graphical user interface 600 may further provide a query 602 to a user to input a more detailed location within the selected location. Moreover, the graphical user interface 600 may include an input box 604 which allows selection of the Miami-Dade area. Finally, the graphical user interface 600 may include an input box 612 for receiving a percentage of usage in this location. In one aspect, once this information is input into the graphical user interface 600, the process 200 may automatically advance. In another aspect, the user may be required to press a continue 610 button or similar input feature to advance the process 200.

In the aspects above, the process 200 may utilize keyboard input or the touch sensitive user interface input to obtain the data from the user. In aspects with the Internet enabled device 194, a keyboard and/or mouse input may be utilized for input in lieu of a touch sensitive user interface. In an alternative aspect, the input may be provided by voice recognition software.

As shown in box 210, the process 200 may query as to whether there are additional locations to input. If there are more locations to input, the process may return to box 202. If there are no more locations to input, the process may advance to box 212.

In box 212, each of the locations that have been input by the user by the one or more graphical user interfaces may be stored in a memory 116 of the wireless device 104. Alternatively or additionally, each of the locations that have been input by the user by the one or more graphical user interfaces may be transmitted from the wireless device 104 or Internet enabled device 194 to a server as described in greater detail below.

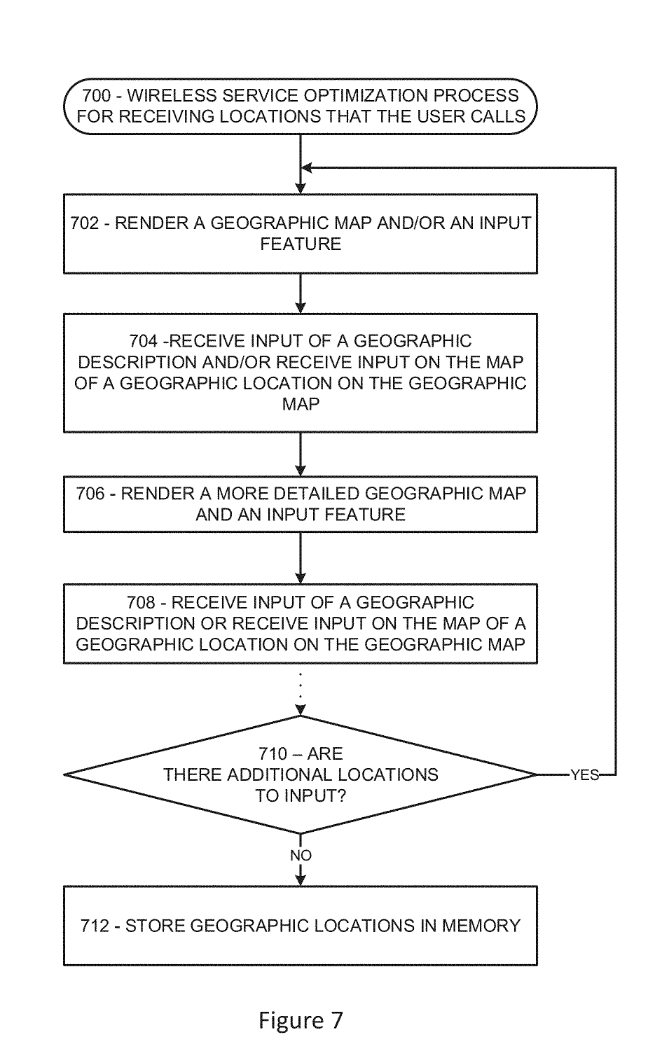

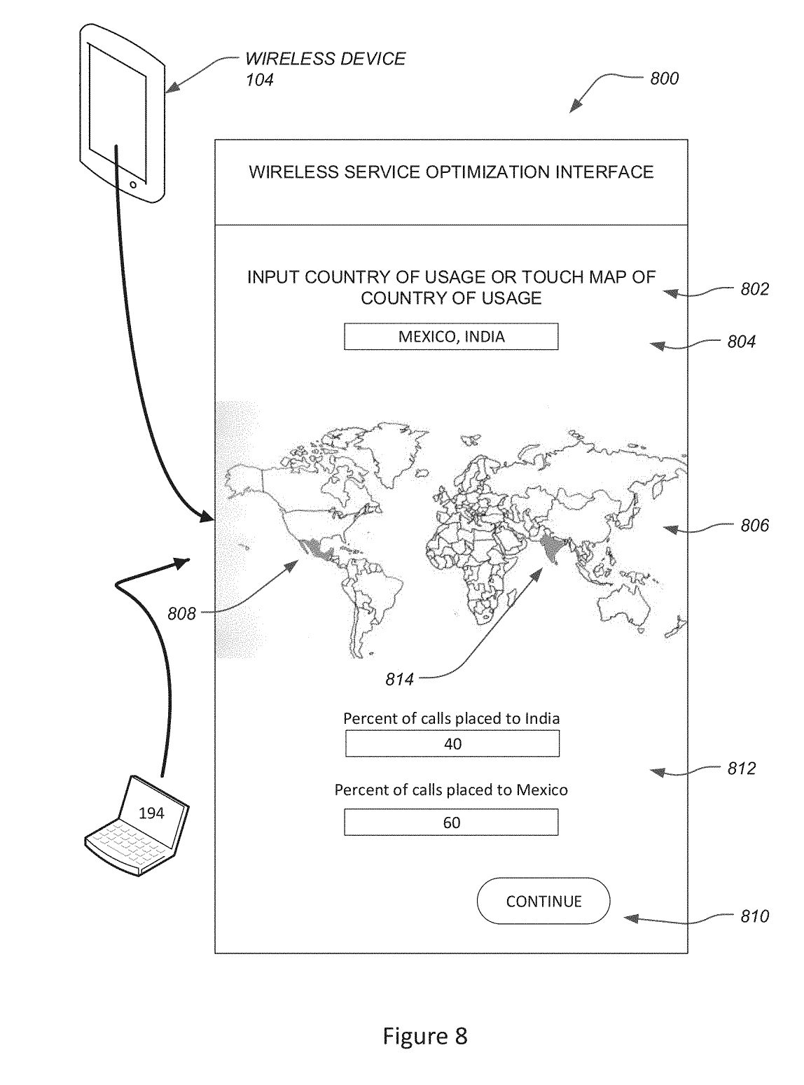

FIG. 7 illustrates a device process in accordance with an aspect of the disclosure; and FIG. 8 illustrates an interface screen of a device in accordance with an aspect of the disclosure. In particular, FIG. 7 illustrates a process 700 for wireless service optimization for receiving locations that the user calls.

As shown in box 702, the wireless device 104 may render a geographic map 806 and/or an input feature 804 in a graphical user interface 800 as illustrated in FIG. 8. In this regard, the geographic map 806 shown in FIG. 8 is of the world. Of course, it should be appreciated that a different map of less than the world may be rendered as well. The graphical user interface 800 may further provide a query 802 to a user to input a country to which they anticipate calling.

Next, as shown in box 704, the graphical user interface 800 may receive input of a geographic description and/or receive an input on a map of a geographic location on the geographic map 806. The graphical user interface 800 of the wireless device 104 may be touch sensitive allowing the user to select various countries in the world that they are likely to call using the wireless device 104. In one aspect, the graphical user interface 800 may allow the user to select multiple countries by touching the geographic map 806 multiple times in different locations. In one aspect, the geographic map 806 illustrated in the graphical user interface 800 may highlight the selected countries by changing color, providing a listing, or the like. In this regard, the user has selected Mexico 808 and India 814. Accordingly, the graphical user interface 800 illustrating the geographic map 806 shows Mexico 808 and India 814 highlighted.

In another aspect, the user may simply type in “Mexico” and “India” in an input feature 804. Thereafter, Mexico 808 and India 814 may be highlighted on the geographic map 806 (as shown), provided as a listing, or the like. Additionally, the input feature 804 may also include a drop-down menu listing of various countries in an alphabetic format, a frequency of use format, or the like, allowing the user to select a particular country. Other manners of inputting the user's location of country of usage are contemplated as well.

In a further aspect, the graphical user interface 800 may also allow the user to further include a percentage of time they call each of these locations. In this regard, an input box 812 may allow a user to input a percent of time they call Mexico 808 and India 814. In this regard, the user anticipates calling Mexico 60% of the time and India 40% of the time of the time. The input box 812 may be implemented in other ways such as a sliding scale, radio buttons, and the like. Moreover, although more than one country is shown selected in the graphical user interface 800, single countries may be selected in a rendering of the graphical user interface 800. In one aspect, once this information is input into the graphical user interface 800, the process may automatically advance. In another aspect, the user may be required to press a continue 810 button or similar input feature to advance the process 700.

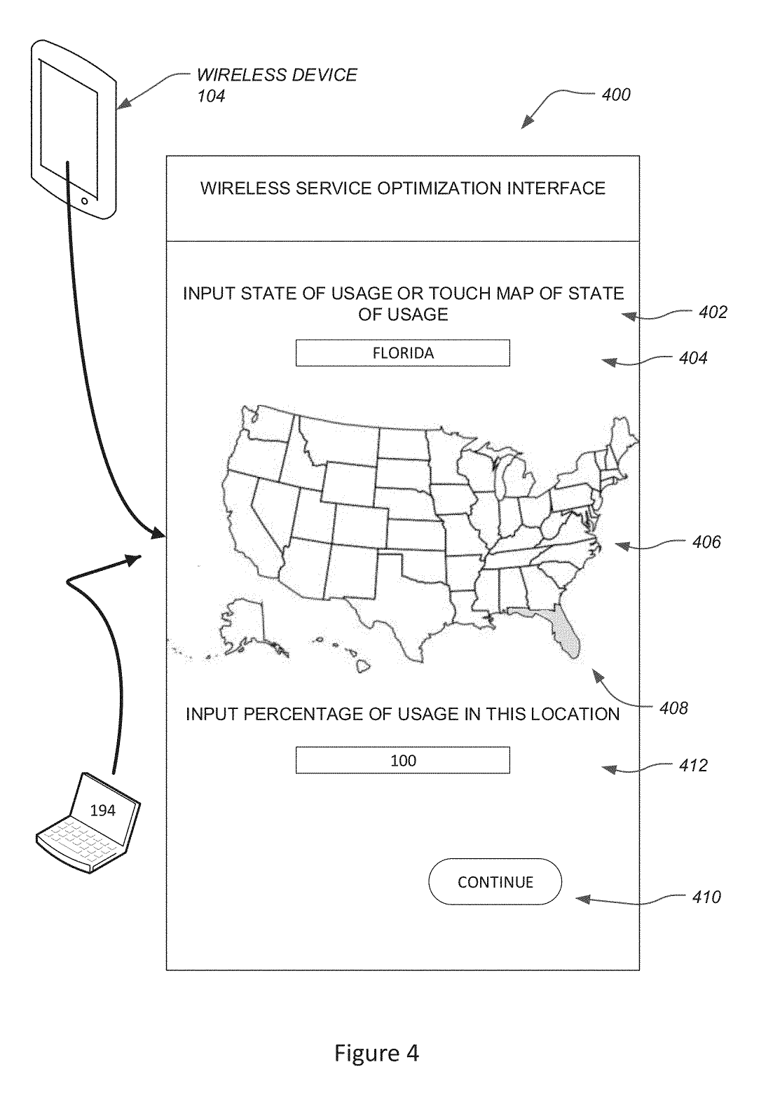

In box 706, the wireless device 104 may render a more detailed geographic map showing greater detail of a selected country and an input feature (not shown). In this regard, the graphical user interface may render a detailed map allowing the user to select and input more detailed locations of where they intend to call utilizing the wireless device 104. The graphical user interface may further provide a query to a user to input a particular location within a selected country. These aspects may be implemented consistent with the implementations illustrated in FIGS. 4-6.

Moreover, as shown by the dashed arrow extending from box 708, the process 700 may continue with additional more detailed renderings of a geographic map and/or input box.

In aspects, the process 700 may utilize keyboard input or the touch sensitive user interface input to obtain the data from the user. In aspects with the Internet enabled device 194, a keyboard and/or mouse input may be utilized for input in lieu of a touch sensitive user interface. In an alternative aspect, the input may be provided by voice recognition software.

As shown in box 710, the process 700 may query as to whether there are additional locations to input. If there are more locations to input, the process may return to box 702. If there are no more locations to input, the process may advance to box 712.

In box 712, each of the locations that have been input by the user by the one or more graphical user interfaces may be stored in a memory 116 of the wireless device 104. Alternatively or additionally, each of the locations that have been input by the user by the one or more graphical user interfaces may be transmitted from the wireless device 104 or Internet enabled device 194 to a server as described in greater detail below.

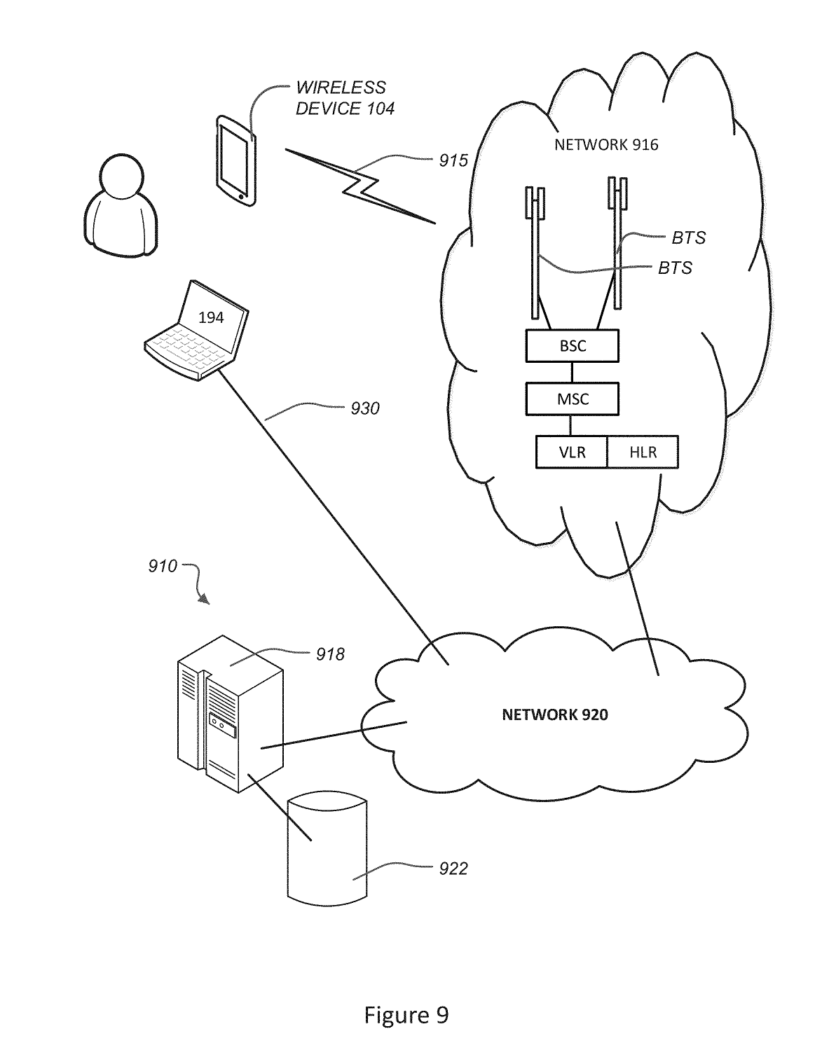

FIG. 9 illustrates a wireless plan optimization system in accordance with an aspect of the disclosure. In one aspect, there is disclosed a wireless plan optimization system 910 as illustrated in FIG. 9. The wireless plan optimization system 910 illustrated in FIG. 9 may be implemented at least in part by a wireless carrier, by third-party system, or the like.

More specifically, the wireless plan optimization system 910 may be used to provide an optimized wireless plan to the wireless device 104 and/or the Internet enabled device 194. The wireless plan optimization system 910 may provide information regarding optimal wireless services for the wireless device 104 and/or the Internet enabled device 194 without requiring access to an agent, website, or wireless/landline telephone system. The wireless plan optimization system 910 may include a database 922 that includes a plurality of wireless service plans, costs associated with these wireless service plan, and an application that is configured to receive the request and search the database 922 to find the optimal wireless service plan based on geographic locations associated with box 212 of the process 200 and box 712 of the process 700, and the amount of voice calls, data usage, and text message usage input by the user noted above. In one aspect, the wireless plan optimization system 910 may be implemented by a server 918.

In one aspect, a user operating the wireless device 104 may execute the wireless service optimization application 106 to obtain information on optimal wireless services. The wireless device 104 then may generate an optimal wireless services request that at least includes the stored geographic locations in memory 116 associated with box 212 of the process 200 and box 712 of the process 700, and the amount of voice calls, data usage, and text message usage input by the user noted above. The request may be transmitted over a communication channel 915 provided over a wireless carrier network 916 from the wireless device 104. The request may be delivered across the wireless carrier network 916 to the wireless plan optimization system 910 for use in obtaining information on the optimal wireless services on the wireless device 104. In one aspect, when the wireless plan optimization system 910 operates outside the wireless carrier network 916, the request may be transmitted over a network 920 such as the Internet.

In one aspect, a user operating the Internet enabled device 194 may execute a browser implementing a webpage rendered by a server 918 executing the wireless service optimization application 106 to obtain information on optimal wireless services. The Internet enabled device 194 may then generate an optimal wireless services request that at least includes the stored geographic locations in memory 116 associated with box 212 of the process 200 and box 712 of the process 700, and the amount of voice calls, data usage, and text message usage input by the user noted above. The request may be transmitted over a communication channel 930, which may include a communication channel as defined herein, and may be delivered over the network 920 to the wireless plan optimization system 910 for use in obtaining information on the optimal wireless services on the wireless device 104. In one aspect, the request may be transmitted over the network 920 such as the Internet.

The wireless plan optimization system 910 may receive the request via a the communication channel 915 and then forward in real time the request to the wireless plan optimization system 910 for obtaining information on the optimal wireless services.

Once the request has been analyzed in the wireless plan optimization system 910, the wireless plan optimization system 910 may send information on the optimal wireless plan to the wireless device 104 and/or Internet enabled device 194 consistent with the process 1000 described in detail below.

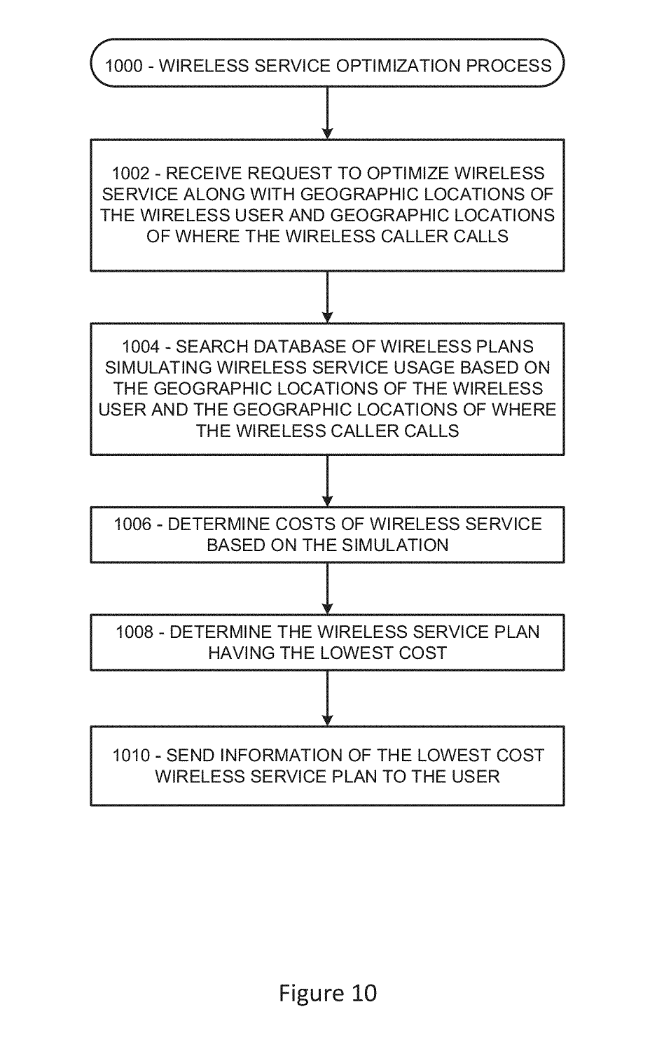

FIG. 10 illustrates a wireless service optimization process in accordance with an aspect of the disclosure. In particular, FIG. 10 illustrates a wireless service optimization process 1000 that may be implemented by the wireless plan optimization system 910 or similar system.

In box 1002, the wireless plan optimization system 910 may receive a request to optimize wireless service along with geographic locations of the wireless user and geographic locations of where the wireless caller calls, and the amount of voice calls, data usage, and text message usage. The request may be sent from the wireless device 104 and/or the Internet enabled device 194 and communicated from these devices over the network 916 and/or the network 920.

Next, in box 1004 the wireless plan optimization system 910 may search the database 922 of wireless plans. Thereafter, the wireless plan optimization system 910 may simulate wireless service usage based on the geographic locations of the wireless user and the geographic locations of where the wireless caller calls, and the amount of voice calls, data usage, and text message usage. In one aspect, the simulation may be implemented in the server 918.

In box 1006, the wireless plan optimization system 910 may determine costs of wireless service based on the simulation for each of the wireless service plans stored in the database 922. In this regard, the determination of cost may include looking up details and information of various wireless service plans in the database 922.

In other aspects, the wireless plan optimization system 910 may utilize an algorithm that includes inputs of the wireless service usage based on the geographic locations of the wireless user and the geographic locations of where the wireless caller calls, and the amount of voice calls, data usage, and text message usage. The wireless plan optimization system 910 may determine costs of wireless service based on the algorithm for each of the wireless service plans stored in the database 922. In this regard, the determination of cost may include looking up details and information of various wireless service plans in the database 922.

In box 1008, the wireless plan optimization system 910 may determine the wireless service plan having the lowest cost. In this regard, the wireless plan optimization system 910 may compare each of the costs associated with the simulation in box 1004 or algorithm and determine the lowest cost.

Finally, in box 1010 the wireless plan optimization system 910 may send information of the lowest cost wireless service plan to the user. The information on the lowest cost wireless service plan may include a link to a webpage to obtain the service, the associated costs of the wireless service, contact information regarding the lowest cost wireless service plan, and the like. This information may be rendered in a graphical user interface of the wireless device 104 and/or Internet enabled device 194.

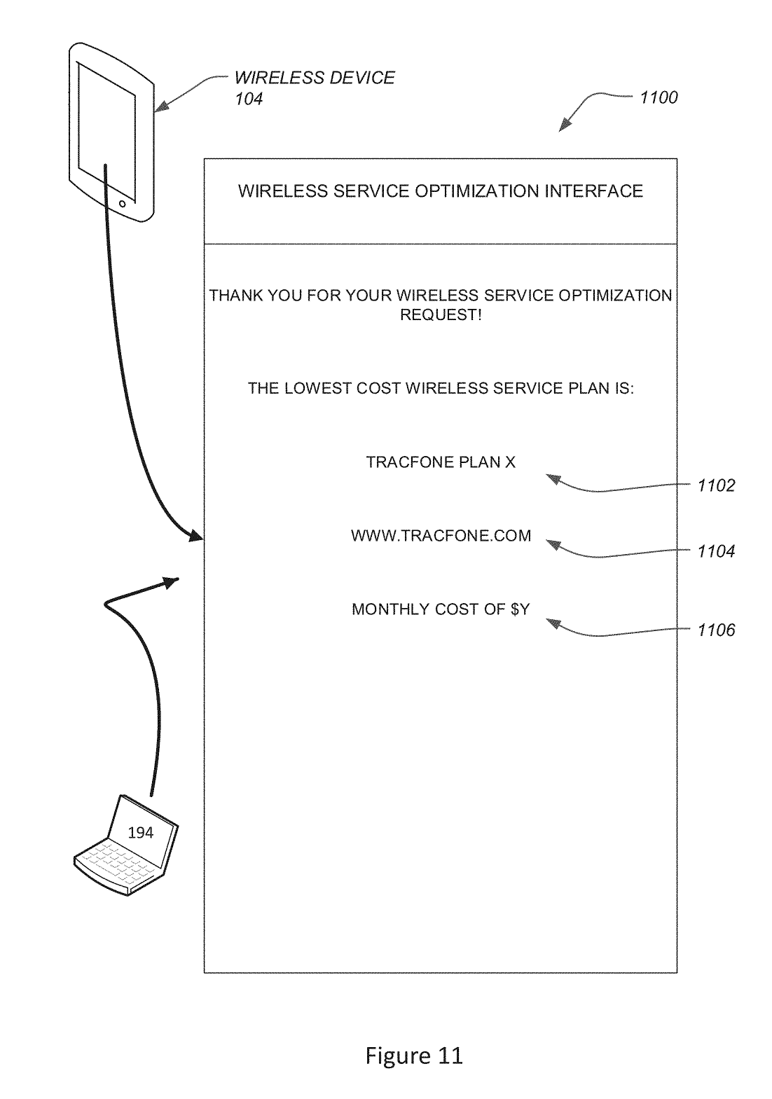

FIG. 11 illustrates an interface screen of a device in accordance with an aspect of the disclosure. In particular, FIG. 11 illustrates a graphical user interface 1100 presented on the wireless device 104 or the Internet enabled device 194. In one aspect, the graphical user interface 1100 may display the lowest cost wireless service plan 1102, a link to a webpage to obtain the service 1104, the associated costs of the wireless service 1106, and the like.

Accordingly, the disclosure has set forth a wireless service optimization process, system, and device that determines from a coverage profile the lowest cost wireless carrier to activate their lines on, and direct them to a billing plan to serve their needs. The coverage profile may include wireless phone calls data usage, text message usage, and the like.

The wireless carrier network 916 may include a Mobile services Switching Center (MSC) that may perform the switching of calls and that may include a Visitor Location Register (VLR). The wireless carrier network 916 may also include a Base Transceiver Station (BTS) and a Base Station Controller (BSC). The base transceiver station houses the radio transceivers that define a cell and handle the radio-link protocols with the wireless device 104. The base station controller manages the radio resources for one or more base transceiver stations. The base station controller is the connection between the wireless device 104 and the Mobile service Switching Center (MSC).

A Home Location Register (HLR) and the VLR together with the MSC, provide the call-routing and roaming capabilities. The HLR contains all the administrative information of each subscriber registered in the corresponding wireless carrier network 916, along with the current location of the wireless device 104. The above is an exemplary implementation of the wireless carrier network 916. Other types of networks utilizing other types of protocols may be implemented as well and are contemplated by the disclosure.

Aspects of the disclosure may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, Near field communication (NFC), a cellular telephone network, a Personal Communications Service (PCS), using known protocols such as the Global System for Mobile Communications (GSM), CDMA (Code-Division Multiple Access), GSM/EDGE and UMTS/HSPA network technologies, Long Term Evolution (LTE), 5G (5th generation mobile networks or 5th generation wireless systems), WiMAX, HSPA+, W-CDMA (Wideband Code-Division Multiple Access), CDMA2000 (also known as C2K or IMT Multi-Carrier (IMT-MC)), Wireless Fidelity (Wi-Fi), Bluetooth, and/or the like, and/or a combination of two or more thereof. The NFC standards cover communications protocols and data exchange formats, and are based on existing radio-frequency identification (RFID) standards including ISO/IEC 14443 and FeliCa. The standards include ISO/IEC 18092[3] and those defined by the NFC Forum.

Aspects of the disclosure may be implemented in any type of computing devices, such as, e.g., a desktop computer, personal computer, a laptop/mobile computer, a personal data assistant (PDA), a mobile phone, a tablet computer, cloud computing device, and the like, with wired/wireless communications capabilities via the communication channels.

Aspects of the disclosure may be implemented in any type of mobile smartphones that are operated by any type of advanced mobile data processing and communication operating system, such as, e.g., an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system, a Linux™ operating system or the like.

Further in accordance with various aspects of the disclosure, the methods described herein are intended for operation with dedicated hardware implementations including, but not limited to, PCs, PDAs, semiconductors, application specific integrated circuits (ASIC), programmable logic arrays, cloud computing devices, and other hardware devices constructed to implement the methods described herein.

It should also be noted that the software implementations of the disclosure as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the disclosure is considered to include a tangible storage medium or distribution medium, as listed herein and including art-recognized equivalents and successor media, in which the software implementations herein are stored.

Aspects of the disclosure may be web-based. For example, a server may operate a web application in conjunction with a database. The web application may be hosted in a browser-controlled environment (e.g., a Java applet and/or the like), coded in a browser-supported language (e.g., JavaScript combined with a browser-rendered markup language (e.g., Hyper Text Markup Language (HTML) and/or the like)) and/or the like such that any computer running a common web browser (e.g., Internet Explorer™, Firefox™, Chrome™, Safari™ or the like) may render the application executable. A web-based service may be more beneficial due to the ubiquity of web browsers and the convenience of using a web browser as a client (i.e., thin client). Further, with inherent support for cross-platform compatibility, the web application may be maintained and updated without distributing and installing software on each.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

Aspects of the disclosure may include a server executing an instance of an application or software configured to accept requests from a client and giving responses accordingly. The server may run on any computer including dedicated computers. The computer may include at least one processing element, typically a central processing unit (CPU), and some form of memory. The processing element may carry out arithmetic and logic operations, and a sequencing and control unit may change the order of operations in response to stored information. The server may include peripheral devices that may allow information to be retrieved from an external source, and the result of operations saved and retrieved. The server may operate within a client-server architecture. The server may perform some tasks on behalf of clients. The clients may connect to the server through the network on a communication channel as defined herein. The server may use memory with error detection and correction, redundant disks, redundant power supplies and so on.

The application described in the disclosure may be implemented to execute on an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system, a Linux™ operating system or the like. The application may be displayed as an icon. The application may have been downloaded from the Internet, pre-installed, or the like. In some aspects, the application may be obtained from Google Play™, Android Market™, Apple Store™, or the like digital distribution source. The application may be written in conjunction with the software developers kit (SDK) associated with an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system, a Linux™ operating system or the like.

Voice recognition software may be utilized in various aspects of the systems and methods. Users may be able to vocalize, rather than utilizing other input processes. For example, the voice recognition software may be configured for generating text from voice input from a microphone or other voice input. A speech signal processor may convert speech signals into digital data that can be processed by the processor. The processor may perform several distinct functions, including serving as the speech event analyzer, the dictation event subsystem, the text event subsystem, and the executor of the application program. The speech signal processor may generate speech event data and transmit this data to the processor to be processed first by the speech event analyzer. The speech event analyzer may generate a list or set of possible candidates among the system recordings that represent or match the voice input processed by the speech signal processor. The speech event analyzer may transmit the candidate sets to a dictation event subsystem. The dictation event subsystem may analyze the candidate sets and choose the best match candidate with the highest degree of similarity. This candidate is then considered the correct translation, and the dictation event subsystem forwards the translation to the text event subsystem which in turn inputs the translated text into the device.

The term text message or SMS refers to “short message service” which is a text messaging service component of phone, web, or mobile communication systems. It uses standardized communications protocols to allow fixed line or mobile phone devices to exchange short text messages. SMS was originally designed as part of GSM, but is now available on a wide range of networks, including 3G, 4G, LTE, 5G networks or networks associated with the communication channel as defined herein. In other aspects, text message may include Multimedia Messaging Service (MMS), which is a standard way to send messages that include multimedia content to and from mobile phones. It extends the core SMS (Short Message Service) capability that allowed exchange of text messages only up to 160 characters in length. While the most popular use is to send photographs from camera-equipped handsets, it is also used as a method of delivering news and entertainment content including videos, pictures, text pages and ringtones. MMS can be used within the context of the present invention for UICC activation message delivery. Of note is that MMS messages are delivered in a completely different way from SMS. The first step is for the sending device to encode the multimedia content in a fashion similar to sending a MIME e-mail (MIME content formats are defined in the MMS Message Encapsulation specification). The message is then forwarded to the carrier's MMS store and forward server, known as the MMSC (Multimedia Messaging Service Centre). If the receiver is on another carrier, the relay forwards the message to the recipient's carrier using the Internet.

The term voice or voice calls as utilized herein may include voice calls defined by 3GPP (3rd Generation Partnership Project) with Voice Call Continuity (VCC) specifications in order to describe how a voice call can be persisted, as a mobile phone moves between circuit switched and packet switched radio domains (3GPP TS 23.206).

The term data as utilized herein includes mobile broadband or wireless Internet access delivered through mobile phone towers over a communication channel as defined herein to computers, mobile phones, wireless devices, and other digital devices as defined herein using portable modems. Some mobile services allow more than one device to be connected to the Internet using a single cellular connection using a process called tethering.

While the disclosure has been described in terms of exemplary aspects, those skilled in the art will recognize that the disclosure can be practiced with modifications in the spirit and scope of the appended claims. These examples given above are merely illustrative and are not meant to be an exhaustive list of all possible designs, aspects, applications or modifications of the disclosure.

What is claimed is:

1. A method for determining optimized wireless service for a wireless device implemented in a device comprising:
displaying on a display of the device a graphical user interface having a prompt to input information, wherein the information comprises at least one of the following: where a wireless user uses their wireless device, where the wireless user calls to with their wireless device, an amount of voice usage, an amount of data usage, and an amount of text message usage;
receiving the information into the graphical user interface displayed on the display of the device;
transmitting the information from the device to a server;
receiving in the device optimized wireless service information from the server; and
displaying the optimized wireless service information in the graphical user interface on the display of the device.

2. The method according to claim 1, wherein the device comprises at least one of the following: a wireless device and an internet enabled device.

3. The method according to claim 2, wherein the device comprises the internet enabled device, the method further comprising:
storing in a non-transitory memory of the server a wireless service optimization application,
wherein the wireless service optimization application is implemented in the server and the server is configured to render a webpage to provide the graphical user interface on the display of the device.

4. The method according to claim 1, wherein the device comprises the wireless device, the method further comprising:
storing in a non-transitory memory of the wireless device a wireless service optimization application,
wherein the wireless service optimization application is implemented in the wireless device and the wireless device is configured to render the graphical user interface on the display of the device.

5. The method according to claim 1, further comprising:
simulating the wireless service with the server based on the information that includes where the wireless user uses their wireless device, where the wireless user calls to with their wireless device, the amount of voice usage, the amount of data usage, and the amount of text message usage.

6. The method according to claim 5, further comprising:
determining a cost of various wireless service plans with the server in response to the simulation based on the information that includes where the wireless user uses their wireless device, where the wireless user calls to with their wireless device, the amount of voice usage, the amount of data usage, and the amount of text message usage.

7. The method according to claim 6, further comprising:
determining a lowest cost wireless service with the server in response to the simulation based on the information that includes where the wireless user uses their wireless device, where the wireless user calls to with their wireless device, the amount of voice usage, the amount of data usage, and the amount of text message usage.

8. The method according to claim 1, further comprising
displaying on the display of the device the graphical user interface that further includes display of a geographic map; and
receiving an indication in conjunction with the geographic map the information that includes where the wireless user uses their wireless device and where the wireless user calls to with their wireless device.

9. The method according to claim 1, further comprising
displaying on the display of the device the graphical user interface that further includes an input feature; and
receiving with the input feature a weightage of wireless usage for at least one of the following: where the wireless user uses their wireless device and where the wireless user calls to with their wireless device.

10. The method according to claim 1, further comprising:
simulating the wireless service with the server based on the information that includes where the wireless user uses their wireless device, where the wireless user calls to with their wireless device, the amount of voice usage, the amount of data usage, and the amount of text message usage;
determining a cost of various wireless service plans with the server in response to the simulation based on the information that includes where the wireless user uses their wireless device, where the wireless user calls to with their wireless device, the amount of voice usage, the amount of data usage, and the amount of text message usage; and
determining a lowest cost of the wireless service with the server in response to the simulation based on the information that includes where the wireless user uses their wireless device, where the wireless user calls to with their wireless device, the amount of voice usage, the amount of data usage, and the amount of text message usage.

11. A device configured to provide wireless service optimization comprising:
a display of the device configured to display a graphical user interface having a prompt to input information, wherein the information comprises at least one of the following: where a wireless user uses their wireless device, where the wireless user calls to with their wireless device, an amount of voice usage, an amount of data usage, and an amount of text message usage;
the graphical user interface displayed on the display of the device being configured to receive the information;
the device further configured to transmit the information to a server;
the device further configured to receive optimized wireless service information from the server; and
the device and display configured to display the optimized wireless service information in the graphical user interface on the display of the device.

12. The device according to claim 11, wherein the device comprises at least one of the following: a wireless device and an internet enabled device.

13. A system comprising the device according to claim 12, wherein the device comprises the internet enabled device, the system further comprising:
the server configured to store in a non-transitory memory a wireless service optimization application,
wherein the wireless service optimization application is implemented in the server and the server is configured to render a webpage to provide the graphical user interface on the display of the device.

14. The device according to claim 11, wherein the device comprises the wireless device, the device further comprising:
a non-transitory memory of the wireless device configured to store a wireless service optimization application,
wherein the wireless service optimization application is implemented in the wireless device and the wireless device is configured to render the graphical user interface on the display of the device.

15. The system according to claim 13, further comprising:
the server configured to simulate the wireless service based on the information that includes where the wireless user uses their wireless device, where the wireless user calls to with their wireless device, the amount of voice usage, the amount of data usage, and the amount of text message usage.

16. The system according to claim 15, further comprising:
the server configured to determine a cost of various wireless service plans in response to the simulation based on the information that includes where the wireless user uses their wireless device, where the wireless user calls to with their wireless device, the amount of voice usage, the amount of data usage, and the amount of text message usage.

17. The system according to claim 16, further comprising:
the server further configured to determine a lowest cost of the wireless service in response to the simulation based on the information that includes where the wireless user uses their wireless device, where the wireless user calls to with their wireless device, the amount of voice usage, the amount of data usage, and the amount of text message usage.

18. The device according to claim 11, further comprising
the display of the device further configured to display the graphical user interface that includes a geographic map; and
the device further configured to receive an indication in conjunction with the geographic map the information that includes where the wireless user uses their wireless device, where the wireless user calls to with their wireless device, the amount of voice usage, the amount of data usage, and the amount of text message usage.

19. The device according to claim 11, further comprising
the display of the device further configured to generate an input feature on the graphical user interface; and
the device further configured to receive with the input feature a weightage of wireless usage for at least one of the following: where the wireless user uses their wireless device and where the wireless user calls to with their wireless device.

20. The system according to claim 13, further comprising:
the server configured to simulate the wireless service based on the information that includes where the wireless user uses their wireless device, where the wireless user calls to with their wireless device, the amount of voice usage, the amount of data usage, and the amount of text message usage;
the server configured to determine a cost of various wireless service plans in response to the simulation based on the information that includes where the wireless user uses their wireless device, where the wireless user calls to with their wireless device, the amount of voice usage, the amount of data usage, and the amount of text message usage; and
the server further configured to determine a lowest cost of the wireless service in response to the simulation based on the information that includes where the wireless user uses their wireless device, where the wireless user calls to with their wireless device, the amount of voice usage, the amount of data usage, and the amount of text message usage.
